(19) United States
(12) Patent Application Publication
(10) Pub. No.: US 2014/0366784 A1
(43) Pub. Date: Dec. 18, 2014

(54) TRANSPORTABLE SAFE

(71) Applicant: David Berger, Toronto (CA)

(72) Inventor: David Berger, Toronto (CA)

(21) Appl. No.: 14/364,008

(22) PCT Filed: Dec. 11, 2012
(86) PCT No.: PCT/CA2012/050888

§ 371 Date: Jun. 9, 2014

Related U.S. Application Data
(60) Provisional application No. 61/569,587, filed on Dec. 12, 2011.

(51) Int. Cl. E05G 1/00; A45B 25/00; G07C 9/00; E05G 1/02

(52) U.S. Cl. CPC E05G 1/005; E05G 1/02; A45B 25/00; G07C 9/00896
USPC 109/23

(57) ABSTRACT

A transportable safe for storing at least one item in a secure compartment has access panel which is operated by an access device to grant selective access to the secure compartment. A communication system has a communication device which includes an input component configured to receive user input and a communication subsystem configured to: (i) communicate with an external device in response to the received user input, and (ii) communicate with and monitor usage of the access device, and transmit access device usage data to the external device. The communication device may include a processor, a memory for storing service request data. The processor may be configured to receive, as an input on the communication device, a service request, store the received service request in the memory, and transmit the service request to the external device.

### CROSS-REFERENCE TO RELATED APPLICATION

This application claims the benefit of and priority to U.S. Provisional Patent Application No. 61/569,587 filed 12 Dec. 2011 under the title PORTABLE SAFE.

The content of the above patent application is hereby expressly incorporated by reference into the detailed description hereof.

### FIELD OF THE INVENTION

Some of the embodiments described herein relate generally to safes and strong boxes used to secure valuable items. Some example embodiments described herein relate to a transportable safe for use around pools of hotels, cruise ships and other recreational spaces.

### BACKGROUND OF THE INVENTION

Persons travelling to the beach, pool, on a cruise ship or other recreational spaces usually carry valuable items with them (i.e. jewelry, credit cards, cell phones, personal identification, laptop computers). Storage at these spaces is usually quite limited, particularly secure storage. As a result, persons may resort to carrying such items with them into the main recreational space (i.e. into the pool) or, if travelling in a group, nominate one person to watch over or guard the valuable items. Depending on the type of valuables, the first option may not be practical (i.e. taking the laptop computer into the pool), and the second option will likely result in reduced enjoyment of the recreational space for the person nominated to guard the valuable items (i.e. less opportunity to swim in the ocean or pool). Furthermore, these excursions are usually brief (i.e. for the afternoon). Under these circumstances, it is not desirable to carry large, cumbersome containers for the purpose of securely storing items.

If these recreational activities take place at a venue in which the use of such recreational spaces is a great source of revenue (i.e. hotel, cruise ship or resort), owners of these venues prefer to limit any factors that may discourage patrons from using these spaces. For example, if the venue features a “swim-up” poolside bar, a high incidence of theft at the venue's pool may discourage patrons from using the pool, resulting in reduced profits for the “swim-up” poolside bar.

Conventional safes are typically secured within a hotel room or at the front desk of a hotel. Typically, their only purpose and function is to secure items for later retrieval.

### SUMMARY OF THE INVENTION

It would be advantageous to address at least some of these above-noted difficulties.

It is an object of the present invention to provide a simple, convenient way for persons to secure valuable items while enjoying typical recreational activities, such as going to the beach, a pool or travelling on a cruise ship. As described herein, the transportable safe provides many features and conveniences for users and for venue owners utilizing the transportable safe. The transportable safe provides a secure compartment for storing valuables including portable electronic devices and provides a communication device for a customer to make communicate with a host venue and/or its staff to make service requests and obtain and transmit information.

In one embodiment there is provided a transportable safe for securely storing at least one item, the transportable safe comprising an outside body, a secure compartment formed within the outside body. The secure compartment is designed to securely store the at least one item. An access panel is operably connected to an access device for granting selective access to the secure compartment. A communication system comprises a communication device attached to the transportable safe including: an input component configured to receive user input; and a communication subsystem configured to: (i) communicate with an external device in response to the received user input, and (ii) monitor usage of the access device, and transmit access device usage data to the external device.

In another embodiment, there is provided a communication system including a communication device attached to the transportable safe. The communication device comprises a processor; and a memory for storing service request data; the processor being configured to: receive, as an input on the communication device, a service request; store the received service request in the memory; and transmit the service request to the external device.

In a further embodiment, the processor is configured to generate related service request data, and transmit the related service request data with the service request to the external device.

In yet another embodiment, there is provided a communication device further comprising a positioning system device, and the related service request data includes position coordinates of the communication device.

In an additional embodiment, there is provided a communication device further comprising a clock, and wherein the related service request data includes date and/or time information of when the service request was inputted.

Further aspects and advantages of the embodiments described herein will appear from the following description taken together with the accompanying drawings.

### BRIEF DESCRIPTION OF THE DRAWINGS

For a better understanding of the embodiments described herein, and to show more clearly how they may be carried into effect, reference will now be made, by way of example only, to the accompanying drawings which show at least one exemplary embodiment, and which:

FIG. 1A is a side perspective view of a transportable safe according to one embodiment of the present application;

FIG. 1B is a portion top view of the transportable safe according to an embodiment of the present application;

FIG. 2A is a portion view of a secure compartment of the transportable safe according to one embodiment of the present application;

FIG. 2B is a portion view of an access device of the transportable safe according to one embodiment of the present application;

FIG. 2C is another portion view of the access device of the transportable safe according to one embodiment of the present application;

FIG. 3A is a side perspective view of the transportable safe according to an embodiment of the present application;

FIG. 3B is a portion view of a storage compartment of the transportable safe according to one embodiment of the present application;

FIG. 4A is a side view of the transportable safe according to one embodiment of the present application;

FIG. 4B is a front view of the transportable safe according to one embodiment of the present application;

FIG. 4C is a back view of the transportable safe according to one embodiment of the present application;

FIG. 5A is a perspective view of the transportable safe according to an embodiment of the present application;

FIG. 5B is a portion view of the transportable safe according to an embodiment of the present application;

FIG. 6 is a perspective view of the transportable safe according to another embodiment of the present application;

FIGS. 7A and 7B are a top view and a side view, respectively, of an umbrella securing device, according to a further embodiment of the present application;

FIG. 8 is a block diagram of a communication device and communication system, according to one embodiment of the present application; and

FIG. 9 is a side perspective view of the transportable safe having a touch screen communication device, according to another embodiment of the present application.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments described herein relate generally to safes and strong boxes used to secure valuable items. In particular, the embodiments described herein relate to a transportable safe for use around pools and other recreational spaces. Furthermore, venue owners (i.e. hotels) are able to utilize the transportable safe described herein to allow guests the freedom and convenience to use their recreational spaces (i.e. pool) at their leisure while their valuables or personal effects are protected. Additionally, the transportable safe provides a communication device for a user of the transportable safe to request services provided by the venue owner.

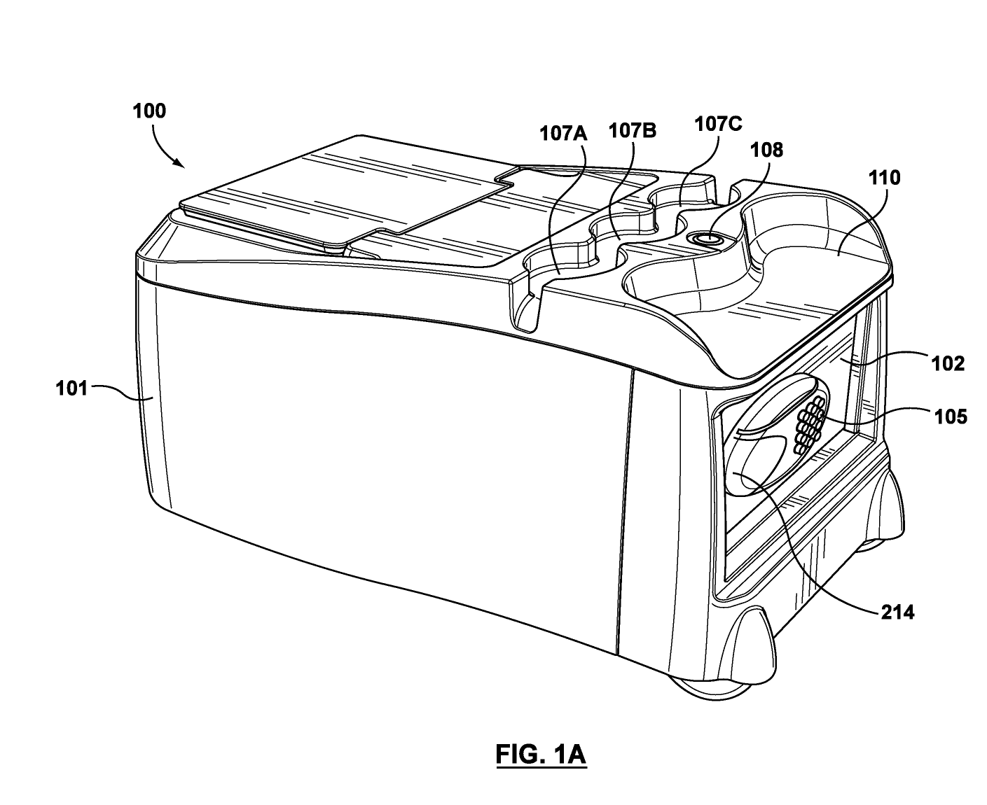

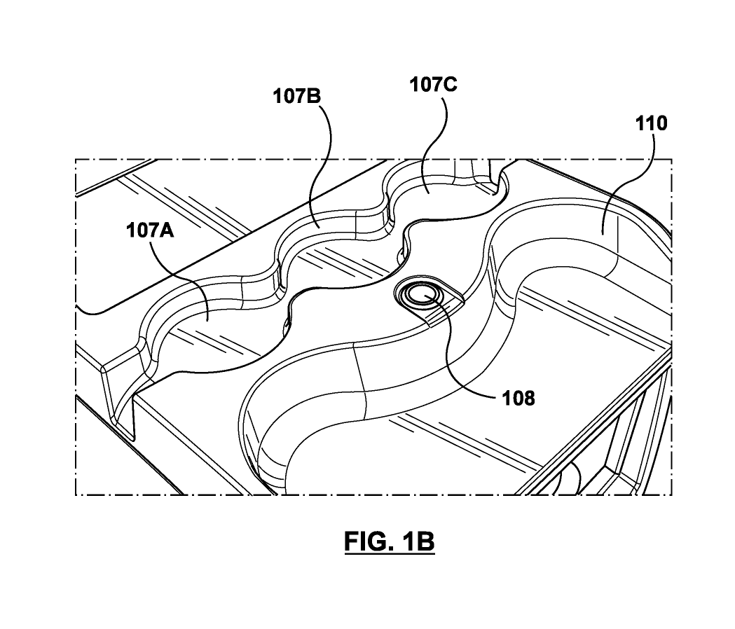

FIG. 1A is a front perspective view of transportable safe 100 according to one embodiment of the present application. Outside body 101 of transportable safe 100 is constructed from a durable material. In one embodiment, outside body 101 is constructed from fiberglass with a steel skeleton shell. Panel 102 provides access to secure compartment (not shown), which is located inside of the outside body 101 and behind the panel 102. In some embodiments, the panel 102 may be a door that opens and closes on at least one hinge or other mechanism that facilitates a swinging movement (opening and closing) of the panel 102 as a door. In other embodiments, panel 102 may slide side to side or up and down to provide access to secure compartment. In one embodiment, handle 214 may be provided to assist in moving panel 102 to access secure compartment. An access device 105 may provide a mechanism to control and provide secure access to the secure compartment. As shown in FIG. 1A, the access device 105 may be located on the panel 102.

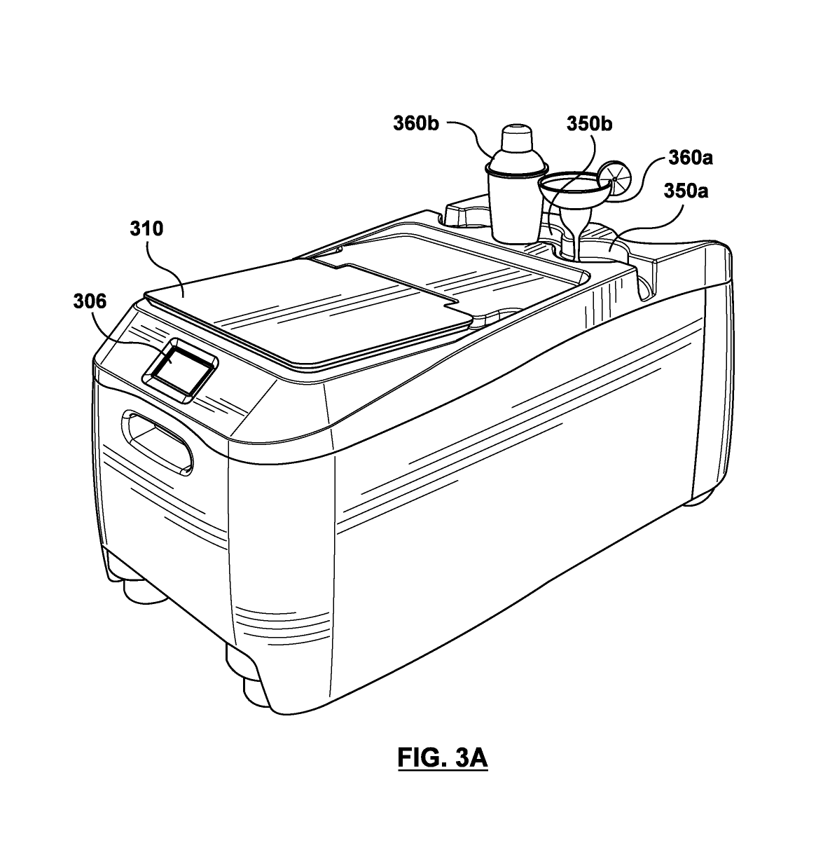

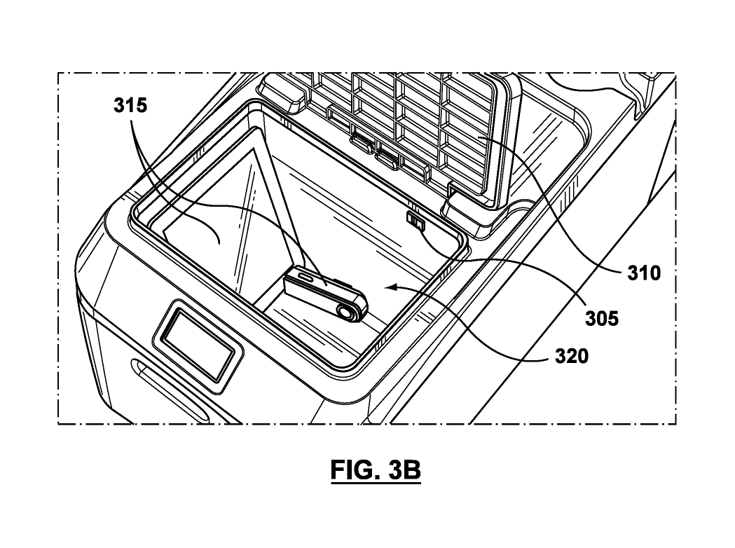

As well, as illustrated in FIGS. 1A and 1B, the transportable safe 100 may include exterior recesses or compartments 107a, 107b, and 107c located on a top side of the transportable safe 100 that may be used to retain beverage containers. In such embodiments, exterior compartments 107a, 107b, 107c may have inserts constructed out of an insulating material (such as, for example, Styrofoam™) to help beverages maintain a preferred temperature. The beverage containers may include beverage glasses, plastic or glass bottles, aluminum cans, paper or plastic coffee cup or any other beverage container. As shown in FIG. 3A, a margarita glass 360a is retained in an outside compartment 350a and a martini shaker 360b is retained in an outside compartment 350b. As well, as shown in FIGS. 1A and 1B, there is an exterior recessed ledge 110 located on the top side of the transportable safe that may be used to place objects such as food or electronic devices. Other shapes and dimensions of the inserts, compartments 107a, 107b, 107c or the ledge 110 may be provided, depending on the particular items being supported.

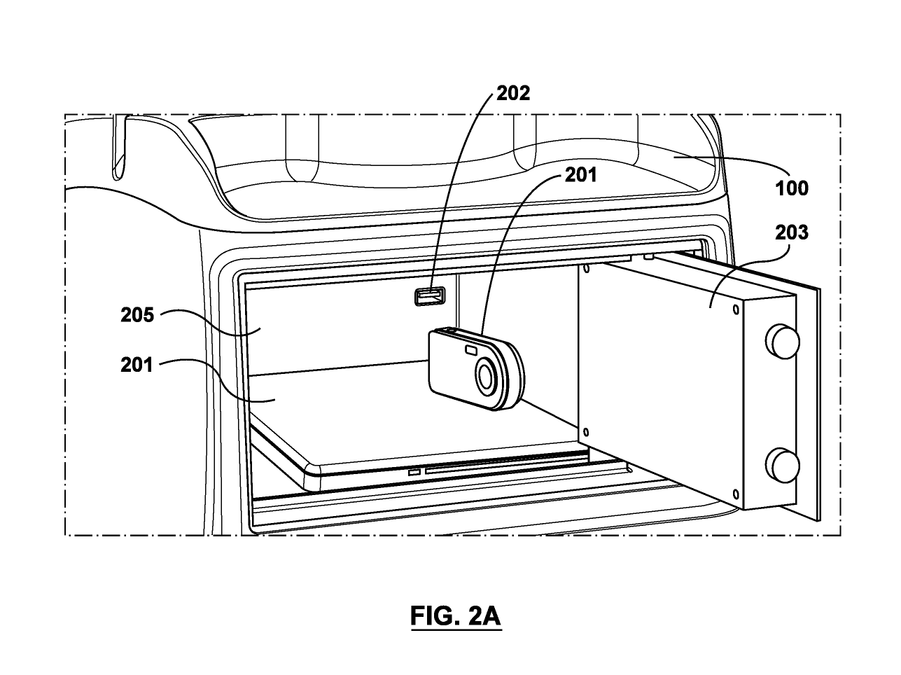

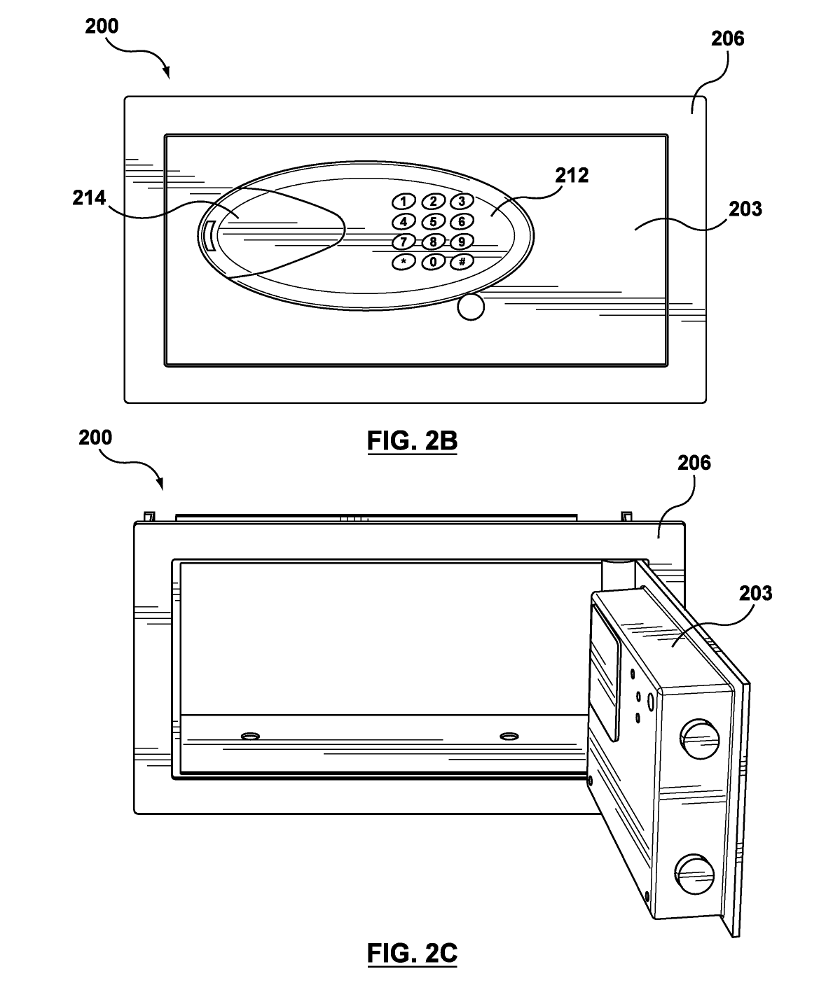

As shown in FIG. 2A, the transportable safe 100 may include a secure compartment 205. Items 201, such as laptops, tablets, mobile phones, cameras and other mobile electronic devices can be locked within the secure compartment 205. The size of the secure compartment 205 may vary in different embodiments. The secure compartment 205 may be accessed by opening a door panel 203. Inside the secure compartment 205, there may be provided one or more ports 202 for charging and/or powering portable electronic devices while the devices are stored in the secure compartment 205. In one embodiment, there is provided a Universal Bus Interface (USB) charging port 202 to charge portable electronic devices. The USB charging port 202 may be powered by a solar panel located on an external surface of the transportable safe 100. In other embodiments, the USB charging port 202 may be powered by a battery stored in the transportable safe 100.

In some embodiments, as shown in FIGS. 2B and 2C, access device 200 is provided for users to lock and unlock the secure compartment 205. As shown in FIG. 2C, the access device 200 may comprise a door panel portion 203 and a frame portion 206. The frame portion 206 may be attached to one side of the transportable safe 100 to enclose an internal compartment of the transportable safe 100, thereby forming the secure compartment 205. The access device 200 may include a handle 214 for opening and closing the door panel portion 203. As well, the access device 200 may be waterproof to ensure safe usage near pools and other areas that include water related activities.

In some embodiments, access device 200 may comprise a physical lock with an accompanying key or, as shown in FIG. 2B, access device 200 may comprise a keypad 212 (for example a digital keypad) located on an exterior side of the door panel portion 203 in which a code (such as, for example, a four-digit code) can be programmed and inputted to lock and unlock the secure compartment 205. For example, a hotel can activate the transportable safe by programming the access device 200 to serve one or more guests. For greater security, the transportable safe 100 may be secured to a particular item or location using a lock and cable (i.e. securing transportable safe 100 to a deck chair, the ground or to an immovable object).

Some embodiments of the transportable safe 100 provide features for additional flexibility and convenience for the user. As shown in FIG. 3A, a power source 306 may be provided as an electrical source for powering and charging of electronic devices, such as laptop computers, mobile phones, tablets, audio devices and other mobile electronic devices. The power source 306 may take various forms, such as a micro solar screen (i.e. solar trickle charger) or a battery located within the transportable safe 100. As previously discussed, the power source 306 may power one or more ports 202, such as an USB charging port for charging and powering portable electronic devices. The power source may also power the access device 200. A battery may also supply power. The one or more ports 202 may be located within the secure compartment 205 or may be located in another compartment of the transportable safe or on an exterior side of the transportable safe.

As illustrated in FIG. 3A, the transportable safe 100 may include a movable lid 310. The lid 310 may open using a hinge or may be slidable. In some embodiments, lid 310 may be covered in a washable material, such as neoprene, and can be used to rest delicate items, such as computers, mobile devices and or electronic products. As well, in an embodiment lid 310 may be removable, making it easier to clean and position as desired. As shown in FIG. 3B, a hinged lid 310 may be moved from a closed position to an open position. In the open position, the lid 310 provides access to a storage compartment 320 that is formed within the transportable safe 100. The storage compartment 320 is of a sufficient size to store mobile electronic devices 315, such as a mobile phone, tablet, camera etc. As well, food, drinks and other items may be stored in the storage compartment 320. When the lid 310 is moved to a closed position, items stored in the storage compartment 320 will be shielded from the sun and other weather or environmental elements. As well, the storage compartment 320 may include one or more ports 305 for charging and/or powering portable electronic devices while the devices are stored in the storage compartment 320. The one or ports 305 may be a USB charging port to charge portable electronic devices.

As shown in FIG. 1A, the transportable safe 100 may include a communication system comprising a communication device 108 to facilitate communications between a customer and venue staff. For example, a customer may utilize the communication device 108 to order drinks or food, or request some other service. The communication device 108 may have a transmitter and/or a receiver (not shown) for communicating using a radio frequency (RF) to another device. The communication device 108 may take a variety of forms, such as a “signal button” as shown in FIG. 1A. In this embodiment, pressing the signal button may send a signal and/or message and/or data to a venue device that sends an alert or notification to venue staff that the customer is requesting service, generally or of a particular nature. For example, a kitchen and/or bar area of a venue may be equipped with a digital box receiver for receiving signals and/or data from the communication device 108. In an example embodiment, a user may press the communication device 108 (i.e., the signal button), which generates and transmits a signal to the digital box receiver. The signal may include a unique identification (ID) number for the particular transportable safe 100. The kitchen and/or bar staff may see the ID number on the digital box receiver to determine which customer is requesting service. As well, in some embodiments, the transportable safe 100 may further include a global positioning system (GPS) device or a local positioning device (LPS), as understood in the art, for identifying the location of each transportable safe 100 unit in venue area.

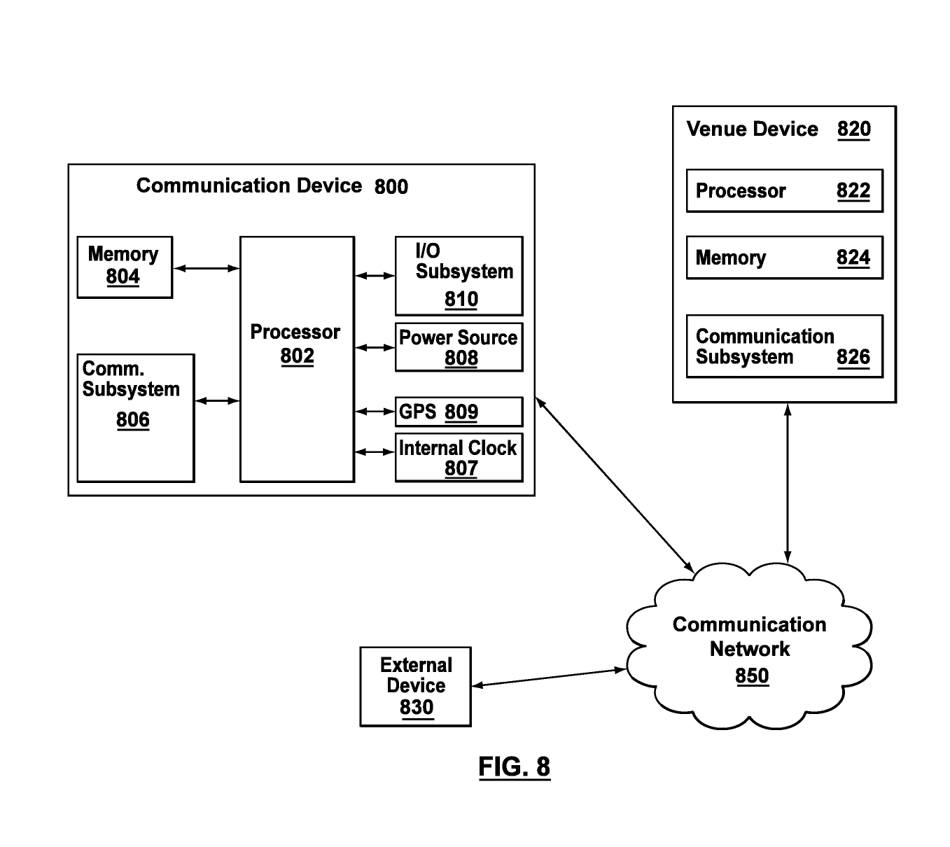

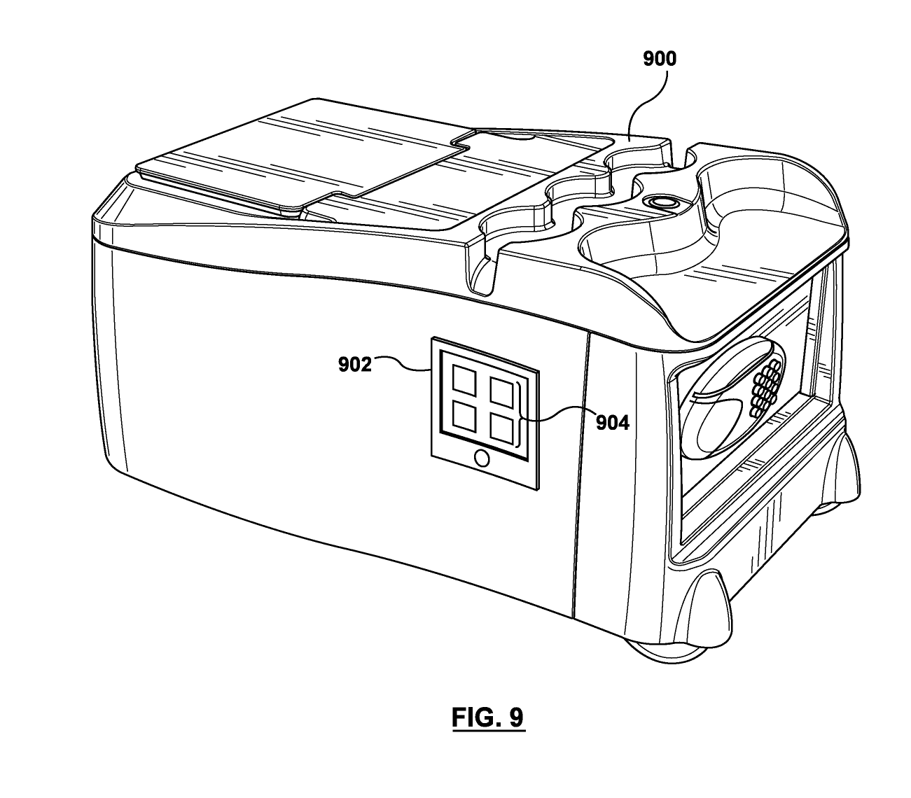

FIGS. 8 and 9 illustrate another embodiment to the communication device. Instead of or in addition to a signal button as shown in FIG. 1A, FIG. 9 illustrates a communication device in the form of a touch screen 902 integrally formed within the transportable safe 900. The touch screen 902 may also be a separate touch screen device that is permanently mounted to the portable device, or that is removably attached to the transportable safe 900 using a tether or other securing device. The touch screen 902 may include an graphical user interface (GUI) 904 that provides selectable options, such as for example, to order food and/or drinks, request a service, view weather information or search local tourism information. For example, after selecting the option to order food and/or drinks, a user may fill out a GUI form and/or utilize a virtual keyboard to specify the items being ordered.

FIG. 8 illustrates the components of the communication device according to some embodiments, such as the touch screen 902. In some embodiments, as shown in FIG. 8, the transportable safe has a communication device 800 that has wireless transmitting capabilities to wirelessly communicate with a venue device or server 820 on a communication network 850. The communication device 800 of the transportable safe may connect to, for example a wireless local area network (WLAN) 850 via a Wi-Fi hotspot that is located at the venue including the pool and/or recreational area. The communication network 850 may be any wireless network, such as a multi-frequency network or a peer-to-peer network.

The venue device or server 820 may include one or more processors 822, a memory 824 for storing statistical data and information, and a communications subsystem 826 for at least receiving data from the communication device 800.

The communication device 800 may include a processor 802, such as a microprocessor, for controlling the overall operation of the communication device 800. The processor 802 interacts with other device components such as a memory 804, a communication subsystem 806, a power source 808 and input/output subsystems 810. The processor 802 may be configured to monitor usage of the transportable safe and its functions. As well, the memory 804 may store statistics and data on the transportable safe usage and the communications subsystem 806 may transmit this usage data to the venue device 820. The power source 808 powers the communication device 800. The power source 808 may be the same power source supplying power to the one or more charging ports previously described. The communication device 800 may be for example, a keyboard or a touch screen device. As well, the communication device 800 may be integrally formed into the transportable safe, mounted to the transportable safe or may be removably attached to the transportable safe. As well, the communication device 800 may include a global positioning system (GPS) device 809, as understood in the art, for identifying the location of the communication device 800.

The communication device 800 may communicate with the venue device 820 to provide statistics, data and service requests. For example, the processor 802 may monitor how many times the secure compartment of the transportable safe is opened and closed via the access device. As well, the processor 802 may monitor the power source 808 of the transportable safe 100. For example, if the transportable safe utilizes a battery, the processor may monitor battery drainage and when the battery reaches a predetermined power level, the processor 802 may be configured to send a signal to the venue device 820 indicating that the battery in the transportable safe needs to be replaced or recharged. In another embodiment, after determining that the battery is low, the processor 802 may be configured to activate a secondary power source, such as an external solar panel, where the external solar panel may transfer power to the battery. Also, the processor 802 may monitor power usage of the power source 808 when a user utilizes the one or more ports located on the transportable safe to charge electronic devices. Statistics regarding power source usage and power levels, as well as access to the secure compartment may be stored in the memory 804. The statistics may be transmitted to the venue device 820 periodically or when the venue device 820 queries the communication device 800 for this data.

In some embodiments, a user may input data, such as food and drink orders and/or service requests via the input subsystem 810 of the communication device 800. The input subsystem 810 may be for example, a keyboard or touch screen device permanently attached or removably attached to the transportable safe. Using the input subsystem 810, the user may input on the keyboard or the touch screen their food and/or drink orders, or other service requests. The processor 802 then will transmit the orders and/or requests directly to the kitchen and/or venue staff via the communications network 850. The venue staff may receive the service requests on the venue device 820 and then may provide the requested service or fulfill the order. The processor 802 may monitor the usage and input received on the communications device 800 to place orders for food and/or drinks or to request a service. The monitoring of the processor 802 may include recording data regarding what particular items are ordered and the time of day the items are ordered. Data regarding the food and/or drink orders, and other service requests, may be stored in the memory 804 of the communication device 800. As well, the processor 802 may generate related service request data, such as location coordinates of the communication device 800 and the date and/or time the service request was inputted. The processor 802 may periodically transmit the service request and the related service request data to the venue device 820. As well, the processor 802 may transmit the data to the venue device 820 after receiving a request signal for the data. The processor 822 of the venue device 820 may send a request for data via the communications subsystem 826. The received data may be stored in the memory 824 of the venue device 820. The processor 822 of the venue device 820 may process the received data by analyzing and performing data manipulation functions. The venue (for example, hotel, resort etc.) may review the raw data or the processed data (ex: statistics) to determine what food and drink items are in demand and/or the time of day or days of increased service requests. With this information, the venue may increase staffing during high demand service periods and may determine ways to increase food and/or drink revenue.

In some embodiments, an external input device 830 that is adapted to communicate with the venue device 820 may be used to communicate food and/or drink orders and other service requests to the venue device 820 via the communication network 850. The external input device 830 may be, for example, a tablet computer, a mobile phone, a portable electronic device, or a laptop computer. The customer may access a venue webpage or application that is hosted on a server (not shown) in order to submit service requests and place food and drink orders to the venue device 820 directly. In another embodiment, the external device 830 is adapted to act as an input device to the communication device 800. The external input device 830 may be used to input and submit service requests via the communication device 800, which will relay the request to the venue device 820 via the communication network 850.

According to some embodiments, the communication device 800 may also include a microphone (not shown) and a speaker (not shown), so that a customer may speak to venue staff to make food and/or drinks orders or other service requests, without requiring the customer to leave their current location.

The communication device 800 may also include one or more applications that provide local tourism information, games or other entertainment services. The one or more applications may be stored in the memory 804 of the communication device 800. As well, a user of the communication device 800 may access the Internet via the communication network 850.

In an embodiment, the transportable safe 100 may also include an internal clock 807 connected to the communication device 800. The processor 802 may utilize the internal clock 807 to lock the access device at night between predetermined hours so that no person may be able to enter a code on the access device to gain access to the secure compartment. As well, the processor 802 may utilize the internal clock 807 to perform tests or checks to ensure the electronic functions of the communication device 800 and the one or more ports are functioning properly. The processor 802 may perform these tests every day or at another predetermined interval, such as every 12 hours.

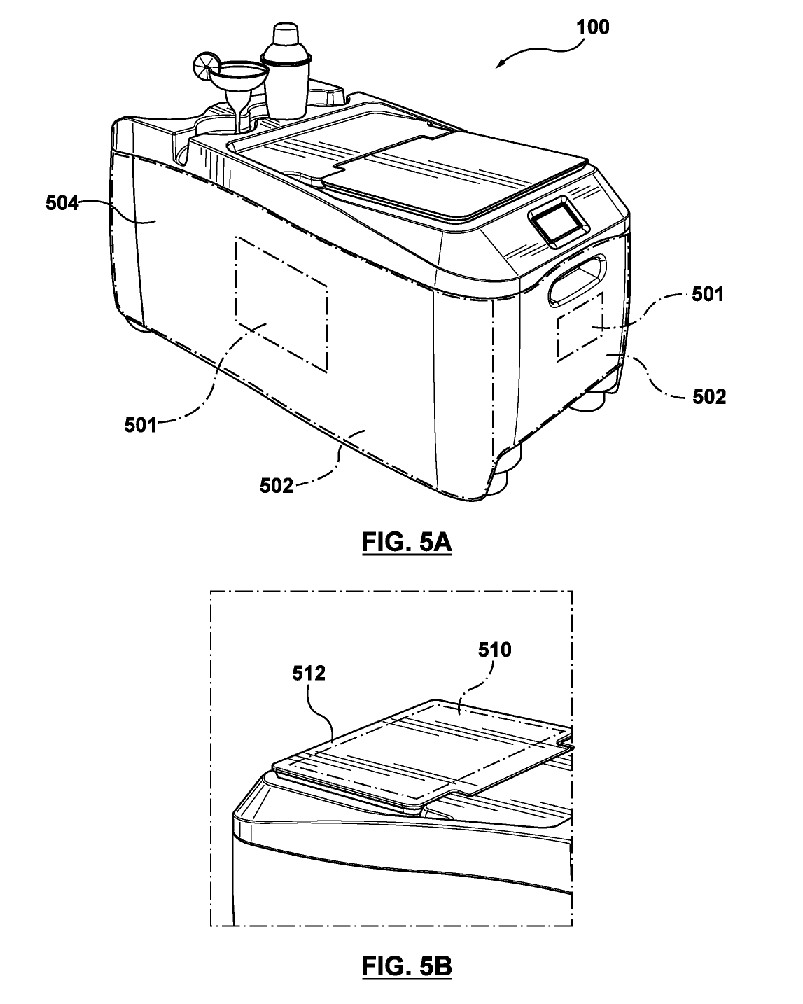

In an embodiment, the transportable safe 100 also provides a convenient space for advertising and branding. As shown in FIGS. 5A and 5B, a logo or trade-mark 501 may be placed on one or more of the sides 502 of the outside body 504 of the transportable safe 100. As well, other images and designs may be affixed to outside body 504. As shown in FIG. 5A, logos 502 are affixed to two sides of the transportable safe 100. As well, in some embodiments as shown in FIG. 5B, a logo 510 may be affixed to the top of the lid 512 that provides access to the storage compartment. In some embodiments, a wraparound shell (not shown) printed with a custom design, message or image may be affixed or mounted to the outside body 504 to create a three dimensional advertisement. The wraparound shell may be constructed from a durable material such as vinyl. In some embodiments, the wraparound shell may also be removable, providing additional flexibility and customizability for new product launches, special events and multiple designs.

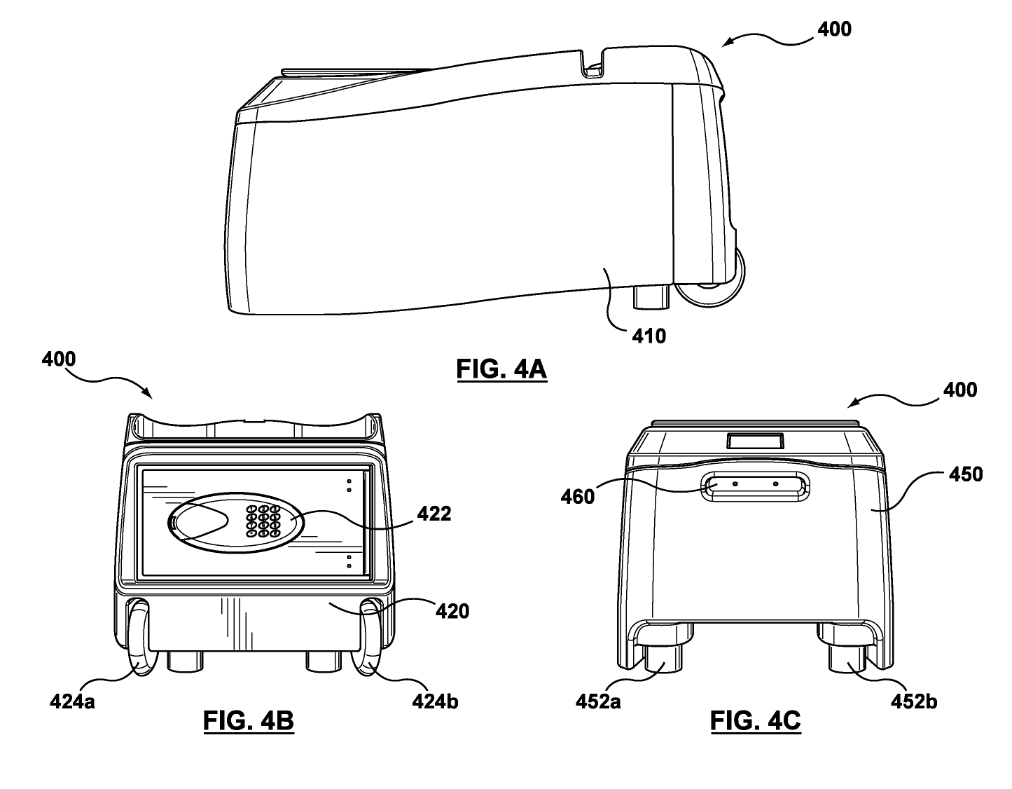

FIG. 4A shows a side perspective view of a further embodiment of the transportable safe 400. As illustrated in FIG. 4A, the transportable safe 400 is generally shaped as a box, such as a rectangular box. Side panel 410 of the transportable safe 400 may have a curvature such that the bottom edge of the side panel 410 slopes upward from one end to another end. The transportable safe 400 may be of different sizes depending on storage and/or space requirements. As well, the transportable safe may be made of different materials, such as a hard plastic.

Users may wish to change the position of transportable safe 400. For example, a user may want to move the transportable safe to a location where there is more or less sun exposure. For easy maneuvering, some embodiments provide for at least one caster and at least one stationary leg. As shown in FIG. 4B, the transportable safe 400 has a front side 420 which includes secure device 422. As well, on the bottom two corners of the front side 420, there may be at least one caster wheel 424a, 424b. As shown in FIG. 4C, the transportable safe 400 has a back side 450. The transportable safe 400 may include stationary legs 452a and 452b, located on the two bottom corners of the back side 450. The stationary legs 452 may be made of any suitable material and may be of varying shape and size. The back side 450 also may include a handle 460. As shown in FIG. 4C, the handle 460 is formed as a recess portion in the back side 450. In other embodiments, the handle may be formed as a protrusion extending from the back side 450.

In operation, a user may lift the transportable safe 400 using the handle 460 to raise the stationary legs 452 off the ground or surface. The user may then push the transportable safe 400 in a forward or backward direction to rotate the caster wheels 424 and move the transportable safe 400 to a new location or position. In other embodiments the caster wheels 424 may rotate to provide movement in all directions, including front, back, left and right.

In different embodiments, the casters may take a variety of forms. For example, the casters may have varying size and wheel radius. As well, the casters may provide a 360 degree turning radius and may be made of any appropriate material. Furthermore, the casters may also lock in place. Selection of the particular caster will depend on a variety of conditions, such as terrain (i.e. tile versus stone traveling surface, degree incline of traveling surface) and expected outdoor conditions. In different embodiments, the stationary pivot leg may take a variety of forms, such as a peg. The stationary leg may also be constructed out a variety of materials, such as rubber.

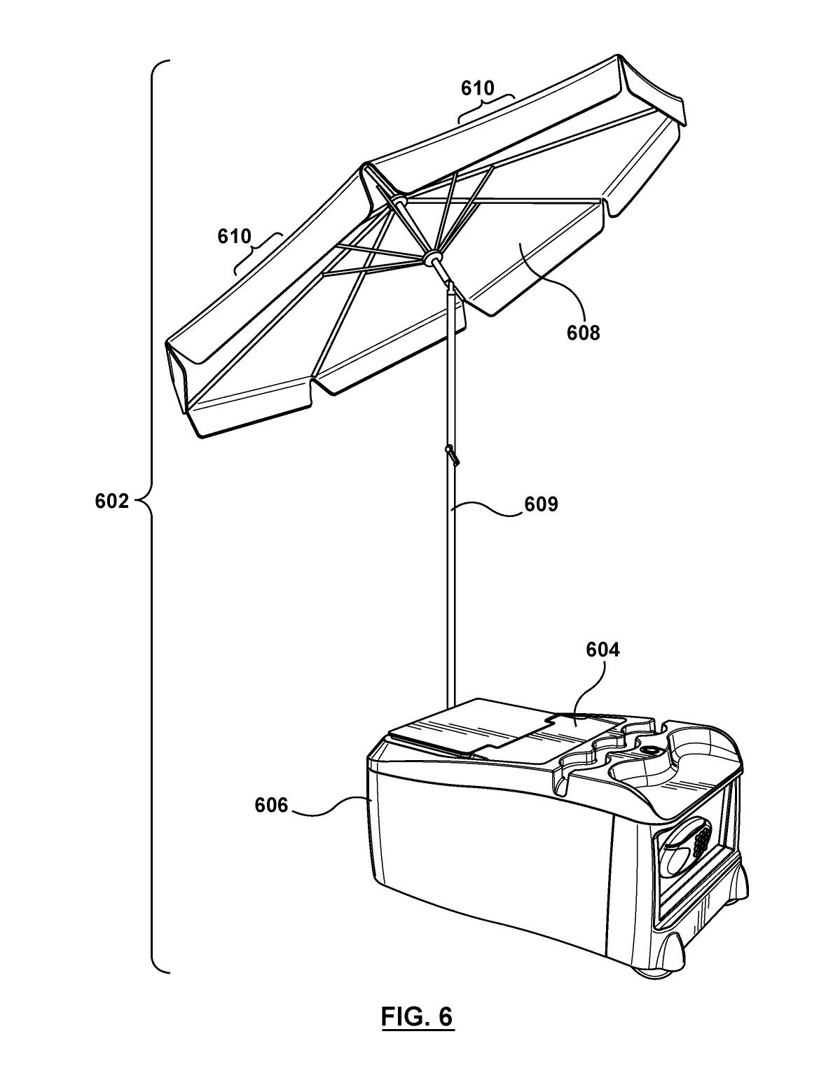

In a further embodiment, an umbrella may be attached to the transportable safe. As shown in FIG. 6, an umbrella 602, such as a large sun umbrella may be attached to the transportable safe 604. The umbrella 602 includes a central rod 609 and a canopy 608 attached to the top end of the central rod 609. In the embodiment shown in FIG. 6, the umbrella 602 is attached to the back side 606 of the transportable safe 604. As well, in some embodiments, one or more solar panels 810 may be secured to the canopy 608 of the umbrella, to provide an additional power source to the transportable safe 604.

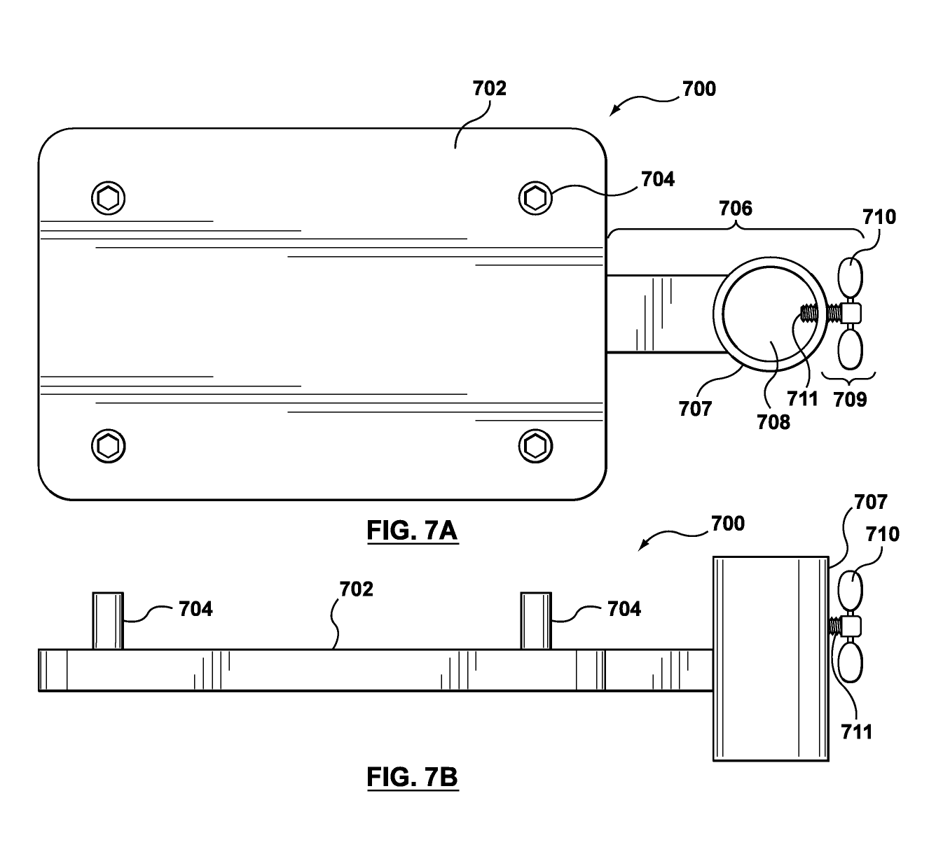

The umbrella 602 may be attached to the transportable safe 604 using securing device 700. FIG. 7A shows a top view of the securing device 700 and FIG. 7B shows a side view of the securing device 700. As shown in FIGS. 7A and 7B, the securing device 700 may include a generally flat surface 702 that includes one or more attachment protrusions 704. In FIGS. 7A and 7B, there are four attachment protrusions 704. The bottom of the transportable safe may include recesses for receiving the complementary attachment protrusions 704. As well, the securing device 700 includes an attachment portion 706 extending from one end of the flat surface 702. The attachment portion 706 may include a tube portion 707 that forms a generally cylindrical space 708. As well, the attachment portion 706 includes a tightening mechanism 709 which may include a rotating handle 710 and a pin 711.

In use, the securing device 700 may be placed under the transportable safe with the protrusions 704 being received into recesses formed in the bottom side of the transportable safe. The securing device 700 may be placed in a manner such that the attachment portion 706 is located on the back side of the transportable safe. The bottom end of the central rod 609 may be inserted into the cylindrical space 708 of the tube portion 707. The central rod 609 may be secured to the securing device 700 by rotating the handle 710 of the tightening mechanism 709 to push the pin 711 against the central rod 609, thereby securing the umbrella to the securing means 700.

The above-described embodiments of the invention are intended to be examples of the present invention and alterations and modifications may be effected thereto, by those of skill in the art, without departing from the scope of the invention which is defined solely by the claims appended hereto.

1. A transportable safe for securely storing at least one item, the transportable safe comprising:
an outside body;
a secure compartment formed within the outside body, the secure compartment for securely storing the at least one item;
an access panel operably connected to an access device for granting selective access to the secure compartment;
a communication system comprising a communication device attached to the transportable safe including:
an input component configured to receive user input, including a service request; and
a communication subsystem configured to: (i) communicate with an external device in response to the received user input, including transmitting the service request to the external device, and (ii) communicate with the access device to receive access device usage data, and transmit access device usage data to the external device; and
a processor configured to generate related service request data.

2. The transportable safe of claim 1, wherein the communication device comprises:
a memory for storing service request data, related service request data and access device usage data.

3. The transportable safe of claim 2, wherein the communication device further comprises a power source, wherein the processor is configured to monitor the power level of the power source.

4. The transportable safe of claim 1, wherein the communication device communicates with the external device on a wireless communication network.

5. The transportable safe of claim 1, wherein the communication device is integrally formed to the transportable safe.

6. The transportable safe of claim 1, wherein the communication device is a touch screen device.

7. The transportable safe of claim 1, wherein the input component is further configured for receiving service requests.

8. The transportable safe of claim 1, wherein the processor is further configured to transmit the related service request data with the service request to the external device.

9. The transportable safe of claim 1, wherein the communication device further comprises a positioning system device, and wherein the related service request data includes position coordinates of the communication device.

10. The transportable safe of claim 1, wherein the communication device further comprises a clock , and wherein the related service request data includes date and/or time information of when the service request was inputted.

11. The transportable safe of claim 2, wherein the processor transmits he service request periodically at a predetermined interval.

12. The transportable safe of claim 2, wherein the processor transmits the service request to the external device in response to receiving a request signal from the external device.

13. The transportable safe of claim 1, wherein the transportable safe further comprises a power source for providing power to one or more input ports for powering or recharging at least one electronic device.

14. The transportable safe of claim 13, wherein the power source is a solar trickle charge pad mounted on a top surface of the transportable safe.

15. The transportable safe of claim 13, wherein the one or more input ports are universal serial bus (USB) ports.

16. The transportable safe of claim 1 wherein the communication device locks the access device during predetermined hours to prevent access to the secure compartment.

17. The transportable safe of claim 1 wherein the access device is waterproof.

18. The transportable safe of claim 1 wherein the access device comprises a keypad.

19. The transportable safe of claim 18 wherein the keypad grants access to the secure compartment in response to the selection of a code associated with the panel.

20. The transportable safe of claim 18 wherein the keypad comprises a digital keypad.

21. The transportable safe of claim 18 wherein the keypad is a touch screen.

22. The transportable safe of claim 1, wherein the transportable safe further comprises at least one stationary leg.

23. The transportable safe of claim 22, wherein the at least one stationary leg is constructed out of rubber.

24. The transportable safe of claim 1, wherein the transportable safe further comprises at least one caster leg.

25. The transportable safe of claim 1, wherein the transportable safe further comprises at least one outside compartment to retain at least one beverage container.

26. The transportable safe of claim 1, wherein the transportable safe further comprises a wraparound shell mounted to the outside body, and wherein the wraparound shell displays a logo or advertising.

27. The transportable safe of claim 1, further comprising a lock and a cable to secure the safe to an immovable object.

28. The transportable safe of claim further comprising an umbrella removably attached to the transportable safe

29. The transportable safe of claim 1, wherein the umbrella further comprises a canopy and wherein one or more solar panels are secured to the top of the canopy for providing power to the transportable safe.

30. The transportable safe of claim 1, further comprising a storage compartment formed within the outside body of the transportable safe.

31. The transportable safe of claim 1, further comprising a moveable lid attached to the outside body for accessing a further storage compartment.

32. The transportable safe of claim 1, wherein the communication device is an external input device that is permanently or removably attached to the transportable safe.

33. The transportable safe of claim 3 where the processor is further configured send a signal to the external device and/or to activate a secondary power source when the power source power supply drops below a set power level.

34. The transportable safe of claim 1, wherein the access device usage data includes information indicating the number of times the secure compartment has been opened or closed.

35. The transportable safe of claim 1, wherein the access device usage data includes information indicating a time and/or date for each time the secure compartment is opened or closed.

36. The transportable safe of claim 1 wherein the related service request data includes statistical information on the type of the received service requests, the frequency of the received service requests, and the date and/or time of the received service requests.

37. The transportable safe of claim 1, wherein the external device analyses the related service request data to determine a time period corresponding to a high frequency of service requests.

38. The transportable safe of claim 1, wherein the external device analyses the related service request data to determine a type of service request that has a high frequency of occurrence.
